(19) United States
(12) Patent Application Publication
(10) Pub. No.: US 2009/0106391 A1
(43) Pub. Date: Apr. 23, 2009

(54) Information delivery apparatus, information delivery method, and information delivery system

(75) Inventor: Honggang WANG, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/287,741

(22) Filed: Oct. 14, 2008

(30) Foreign Application Priority Data
Oct. 19, 2007 (JP) P2007-273114

(51) Int. Cl. G06F 15/16

(52) U.S. Cl. 709/217

(57) ABSTRACT

An information delivery apparatus is disclosed which delivers update information about a specific resource designated by a terminal to the terminal, the information delivery apparatus includes: a delivery section configured to receive from the terminal a request to deliver the update information about the resource and for delivering the update information to the terminal; and an update information generation section configured to generate the update information about the resource upon detection of an update of the resource, before outputting the generated update information to the delivery section; wherein, the moment the update information is acquired from the update information generation section, the delivery section delivers the acquired update information to the terminal.

### CROSS REFERENCES TO RELATED APPLICATIONS

The present invention contains subject matter related to Japanese Patent Application JP 2007-273114 filed with the Japan Patent Office on Oct. 19, 2007, the entire contents of which being incorporated herein by reference.

### BACKGROUND OF THE INVENTION

1. Field of the Invention

The present invention relates to an information delivery apparatus, an information delivery method, and an information delivery system. More particularly, the invention relates to an information delivery apparatus, an information delivery method, and an information delivery system for delivering update information about a specific resource designated by a terminal.

2. Description of the Related Art

Among the means through which to publish or deliver update information from Web sites, RSS (Really Simple Syndication/RDF (Resource Description Framework) Site Summary) and Atom are well known. RSS or Atom (called RSS/Atom hereunder) is the format in which to express structurally, using XML (Extensible Markup Language), the attribute information about the data posted at Web pages. The data written in RSS/Atom is called a feed. An RSS/Atom feed may include the title and a summary of a Web site and update date information.

In recent years, RSS/Atom feeds have been used not only to deliver update information but also to distribute press releases, new product information, and support information. The RSS/Atom feed is also used to publish audio data files. Users may acquire RSS/Atom feeds by utilizing an RSS/Atom compliant browser, dedicated software called the RSS/Atom reader, or a reader-equipped Web browser. The user can thus obtain update information without actually accessing information sources such as Web pages. Japanese Patent Laid-open No. 2005-284334 discloses a technique for delivering update information from a Web site using RSS.

### SUMMARY OF THE INVENTION

An RSS/Atom feed is automatically generated illustratively when information is updated at a Web site. The feed thus generated is stored in a Web server. Upon receipt of a feed acquisition request from a client (i.e., RSS/Atom compliant browser or RSS/Atom reader), the requested RSS/Atom feed is delivered to the client.

That is what is known as client pull, a technique that allows clients periodically to access and acquire RSS/Atom feeds. The so called get method or post method is used to acquire RSS/Atom feeds. At regular intervals typically determined by the user beforehand, a GET/POST command requesting acquisition of an RSS/Atom feed is sent from the client to an RSS/Atom server. Every time the GET/POST command is received, the server returns the RSS/Atom feed to the requesting client.

The feed acquisition request is made by the client whether or not the RSS/Atom feed has been updated. That is, the RSS/Atom feed is transmitted even if the corresponding feed has not been updated. This leads to unnecessary access being made by the client to the server, causing inordinate burdens on the server and the lines involved.

With such client pull delivery, the date on which information is actually updated by the server is almost always different from the date on which the client sends an RSS/Atom feed acquisition request to the server. It follows that the user is unable to obtain update information and others from Web sites in real-time.

The present invention has been made in view of the above circumstances and provides arrangements such that whenever target data (i.e., resource) is updated, the update information is delivered to the user in real-time.

In carrying out the present invention and according to one embodiment thereof, there is provided an information delivery apparatus (i.e., server) for delivering update information about a specific resource designated by a terminal (i.e., client) to the terminal, the information delivery apparatus including: a delivery section configured to receive from the terminal a request to deliver the update information about the resource and deliver the update information to the terminal; and an update information generation section configured to generate the update information about the resource upon detection of an update of the resource, before outputting the generated update information to the delivery section; wherein, the moment the update information is acquired from the update information generation section, the delivery section delivers the acquired update information to the terminal.

The information delivery apparatus of the above described structure carries out a whole series of steps ranging from the detection of a resource update to the notification of resource update information. The moment the resource of interest is updated, relevant resource update information is delivered by the apparatus to the requesting client.

According to the present invention embodied illustratively as outlined above, update information about a resource is generated as soon as an update of that resource is detected. The generated update information is delivered immediately to the client involved. This means that the user of the client can acquire resource update information on a real-time basis.

Because the entire series of steps ranging from the detection of a resource update to the notification of resource update information are performed by the information delivery apparatus, it is not necessary for the client to query the information delivery apparatus for resource updates. This feature alleviates burdens on the information delivery apparatus and on communication lines.

### BRIEF DESCRIPTION OF THE DRAWINGS

FIG. 1 is a schematic view explanatory of how a system is configured as a first embodiment of the present invention;

FIG. 2 is a block diagram showing a typical internal structure of a SIP (session initiation protocol) server as part of the first embodiment;

FIG. 3 is a block diagram showing a typical internal structure of a client as part of the first embodiment;

FIG. 4 is a sequence diagram showing typical steps performed by the first embodiment, the steps ranging from the request for subscription to a feed and the acquisition of a resource;

FIGS. 5A and 5B are schematic views illustrating descriptions of SIP messages, FIG. 5A giving a typical description of a SUBSCRIBE message, FIG. 5B indicating a typical description of a NOTIFY message;

FIG. 6 is a schematic view showing a typical feed description provided by the first embodiment;

FIG. 7 is a schematic view showing another typical feed description provided by the first embodiment;

FIG. 8 is a schematic view showing a typical display of resource update information provided by the first embodiment;

FIG. 9 is a schematic view showing another typical feed description provided by a variation of the first embodiment;

FIG. 10 is a schematic view explanatory of how a system is configured as a second embodiment of the present invention;

FIG. 11 is a sequence diagram showing typical steps performed by the second embodiment, the steps ranging from the request for subscription to a feed and the acquisition of a resource;

FIG. 12 is a schematic view showing a typical feed description provided by the second embodiment;

FIG. 13 is a sequence diagram showing other typical steps performed by the second embodiment, the steps ranging from the request for subscription to a feed and the acquisition of a resource;

FIGS. 14A and 14B are schematic views showing other typical feed descriptions provided by the second embodiment;

FIG. 15 is a schematic view explanatory of how a system is configured as a third embodiment of the present invention;

FIG. 16 is a sequence diagram showing typical steps performed by the third embodiment, the steps ranging from the request for subscription to a feed and the acquisition of a resource; and

FIG. 17 is a schematic view showing a typical feed description provided by the third embodiment.

### DETAILED DESCRIPTION OF THE PREFERRED EMBODIMENTS

### First Embodiment

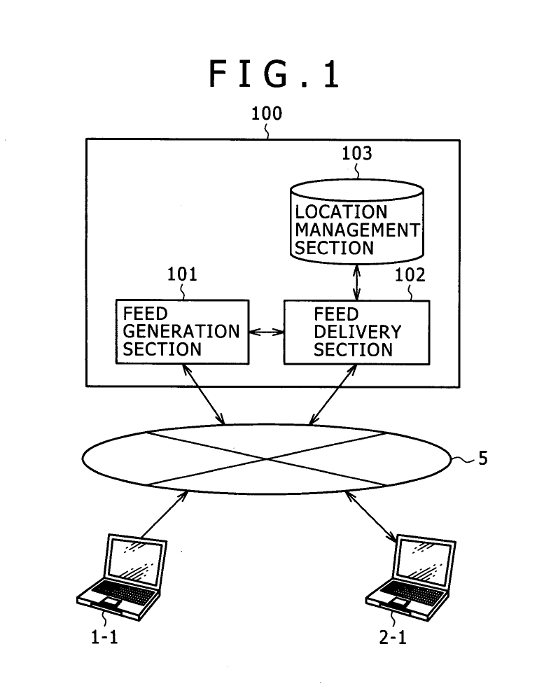

The preferred embodiments of the present invention will now be described in reference to the accompanying drawings. Described first in reference to FIGS. 1 through 8 is the first embodiment of the invention practiced in the form of an information delivery system. This information delivery system constitutes an IPTV setup that delivers TV programs and movies over an IP (Internet Protocol) network. The IPTV setup is implemented using a technique known as IMS (IP Multimedia Subsystem) for offering multimedia services over packet networks. In this context, the term “resource” used in connection, with the preferred embodiments refers to contents such as videos delivered on IPTV.

FIG. 1 schematically shows how the system is configured as the first embodiment of the present invention. In FIG. 1, a SIP server 100 and clients 1-1 and 2-1 are interconnected via a network 5. The user of the client 1-1 is a resource holder who generates or updates IPTV video contents. The user of the client 2-1 receives and views the contents generated or updated by the resource holder.

The SIP server 100 is made up of a feed generation section 101 serving as an update information generation section, a feed delivery section 102, and a location management section 103. The moment an update notice is received from the resource holder 1-1, the feed generation section 101 generates a feed that includes content update information and forwards the generated feed to the feed delivery section 102. Upon receipt of a feed subscription request from the client 2-1, the feed delivery section 102 sends to the location management section 103 the type of the feed to which subscription is requested, together with information about the client requesting the subscription. The feed delivery section 102 further delivers the feed coming from the feed generation section 101 to the client 2-1 requesting the subscription to the feed.

The location management section 103 accepts registration of information about the correspondence between the IDs of the clients written in SIP URIs (Uniform Resource Indicators) on the one hand, and the transport addresses (i.e., IP addresses and port numbers) of the clients on the other hand, as well as registration of information about the locations where the contents held by the resource holder are stored. The location management section 103 also permits registration of information about the correspondence between the type of each resource to which subscription is requested on the one hand, and the client requesting that subscription.

Although not shown in FIG. 1, the SIP server 100 also functions as a proxy server that mediates SIP messages between the client 1-1 and the client 2-1.

Although only two clients 1-1 and 2-1 are shown in FIG. 1, this does not mean that the number of clients that may be configured is limited to two. In FIG. 1, the role of the resource holder and that of the user are shown fixed to particular clients for purpose of simplification and illustration. In practice, these roles may be switched depending on the user's operations. For example, if a client sends a request for delivery of resource update information (i.e., for feed subscription) to the SIP server 100 or has acquired a content over the network 5, then that client becomes the user. The client may further generate or update resources while viewing the acquired content. In such a case, one client is regarded as both a resource holder and a user.

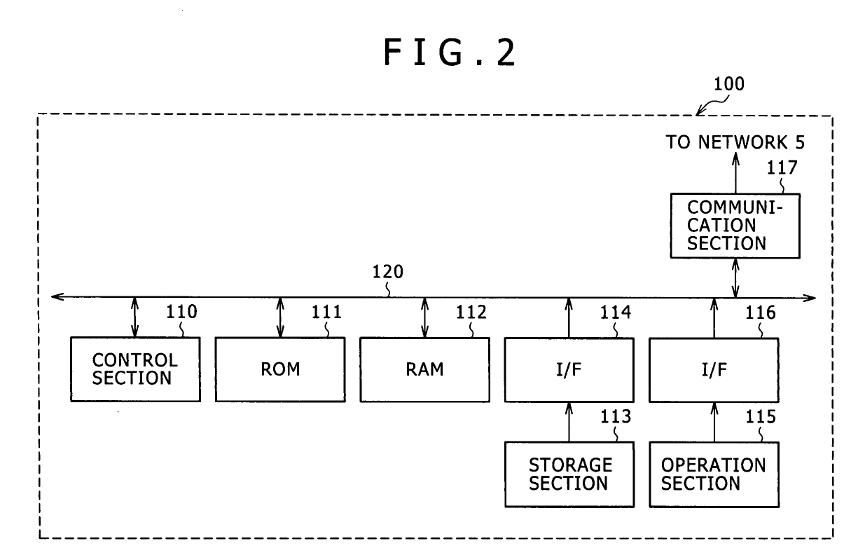

How the SIP server 100 is structured will now be described by referring to FIG. 2. The SIP server 100 is made up of a control section 110, a ROM (read only memory) 111, a RAM (random access memory) 112, a storage section 113 typically composed of a hard disk drive, an operation section 115 constituted generally by a keyboard and a mouse, and a communication section 117.

The control section 110 performs various processes in accordance with the programs stored in the ROM 111 or with those loaded into the RAM 112. The RAM 112 also accommodates the data needed by the control section 110 in carrying out its diverse processing. The feed generation section 101 and feed delivery section 102 explained above in reference to FIG. 1 operate under control of the control section 110. The location management section 103 also discussed above by referring to FIG. 1 may be implemented inside the storage section 112. The feed output by the feed delivery section 102 is sent to the client 2-1 through the communication section 117 and over the network 5.

The above mentioned component sections are interconnected via a bus 120. The storage section 113 and operation section 115 are connected to the bus 120 through interfaces (I/F) 114 and 116, respectively.

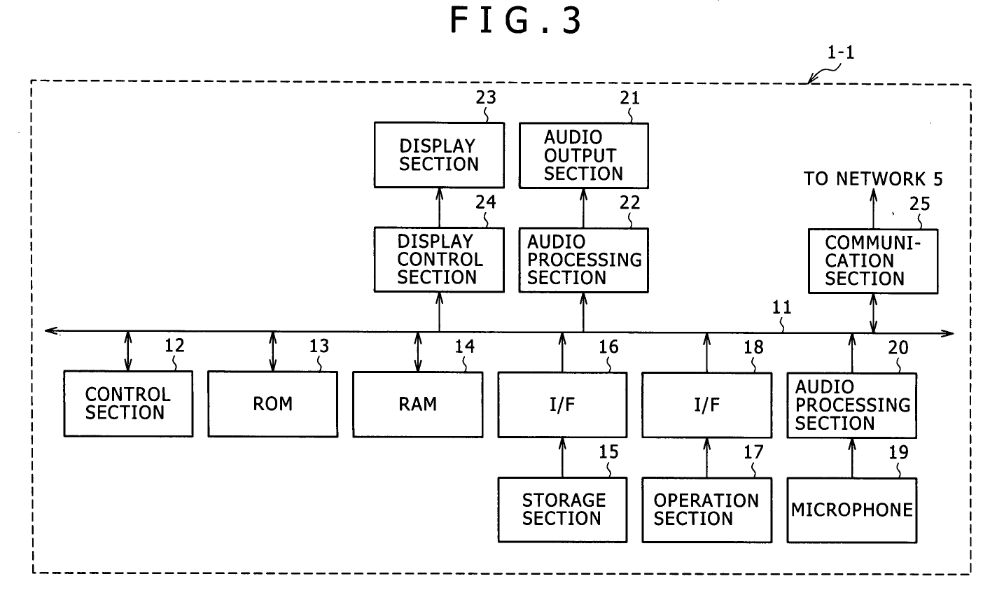

Described below in reference to FIG. 3 is a typical structure of the clients 1-1 and 2-1. In the first embodiment, the clients 1-1 and 2-1 are assumed to have the same structure. The client 1-1 (or 2-1) is made up of a control section 12, a ROM 13, a RAM 14, a storage section 15, an operation section 17, a microphone 19, an audio processing section 20, an audio output section 21, an audio processing section 22, a display section 23, a display control section 24, and a communication section 25. These component sections are interconnected via a bus 11. The storage section 15 and operation section 17 are connected to the bus 11 through interfaces 16 and 18, respectively.

The control section 12, ROM 13, RAM 14, storage section 15, operation section 17, display section 23, display control section 24, and communication section 25 are structurally the same as their counterparts of the SIP server 100 and thus will not be discussed further. The audio processing section 20 converts analog audio signals coming from the microphone 19 into digital audio data and compresses the converted data as needed. The audio processing section 22 expands compressed digital audio data placed on the bus 11 into analog audio signals. The audio output section 21 is formed by speakers and or headphones.

The client 2-1 of the above described structure receives a feed from the SIP server 100 through the communication section 25. The received feed is forwarded to the control section 12 over the bus 11. The control section 12 puts the feed to syntax analysis or like scrutiny. The analyzed feed is converted by the control section 12 into data typically in HTML (Hyper Text Markup Language). The converted data is output as update information to the display control section 24. Under control of the display control section 24, the update information is displayed on the display section 23. Although the feed is shown converted into HTML documents in the above example, this is not limitative of the invention. The feed may alternatively be converted to any other data format compatible with the display format of the display section 23.

The update information displayed on the display section 23 includes storage location information in the form of links indicative of the locations where the contents of interest are stored. When a link is selected by the user operating the operation section 17, a connection request is sent through the communication section 25 to the client 1-1 acting as the holder of the content in question. After the client 1-1 has accepted the connection request and a connection (i.e., media session) is established with the client 1-1, the content selected earlier by the user is transmitted from the client 1-1 to the client 2-1.

If the content coming from the client 1-1 includes video data, then the video data is sent to the display control section 24 through the bus 11. After undergoing decryption and other processing performed by the display control section 24, the video data is output to the display section 23 and displayed thereon as an image. If the content includes audio data, then the audio data is sent to the audio processing section 22 through the bus 11. Following data expansion and other processing carried out by the audio processing section 22, the audio data is output from the audio output section 21.

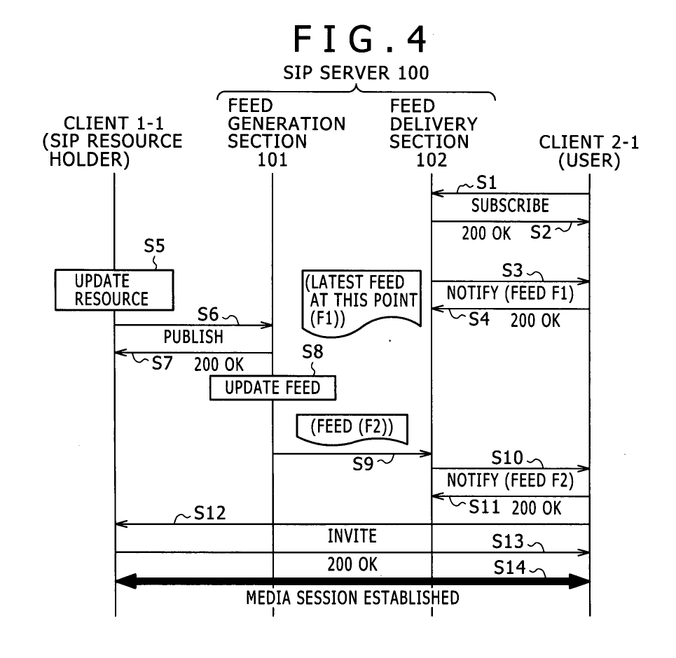

Described below in reference to FIG. 4 are typical steps performed in such a manner that the client 2-1 sends a feed subscription request to the SIP server 100, that the SIP server 100 delivers a feed as content update information to the client 2-1, and that the client 2-1 acquires the content of interest based on the delivered content update information. In FIG. 4, the content update information that the client 2-1 desires to be notified of is assumed to be update information about the electronic program guide (EPG) of TV programs to be broadcast on IPTV.

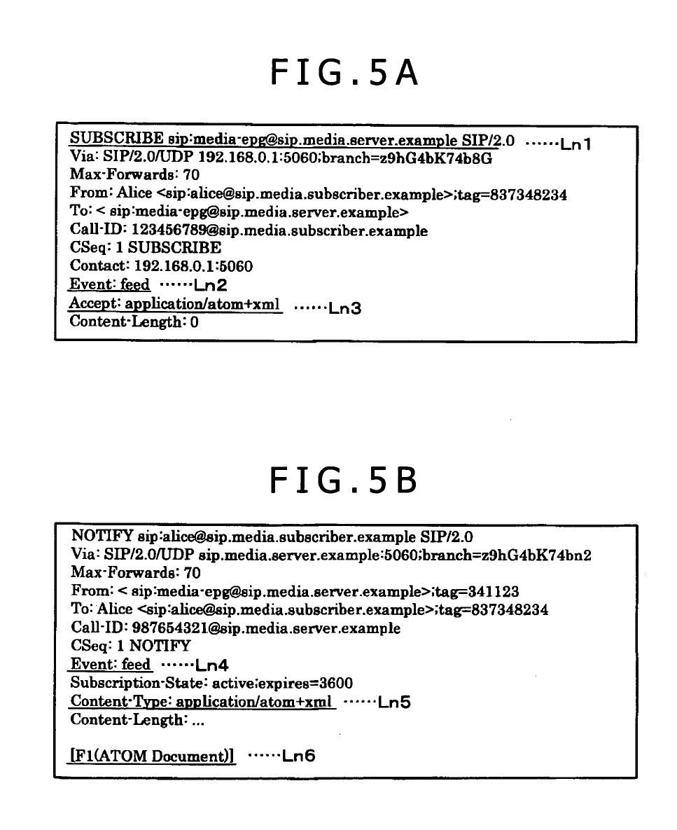

In step S1, the client 2-1 acting as the user describes, in a request line of a SUBSCRIBE request, the type of the content of which the update information is desired to be delivered before sending the SUBSCRIBE request as a feed subscription request to the feed delivery section 102 of the SIP server 100. A typical description of the SUBSCRIBE request to be sent at this point is shown in FIG. 5A. The first line “Ln1” in FIG. 5A is the request line. In a “Request-URI” portion of the request line, “sip:media-epg-pl@sip.media.server.example” is designated. This means that the user of the client 2-1 requests subscription to the update information about the resource managed with the URI “sip:media-epg-pl@sip.media.server.example.”

In an “Event” header of a line Ln2, an event name “feed” is designated. The line Ln2 specifies that the type of the event that the user desires to be notified of is to be “feed.” In an “Accept” header of a line Ln3, “application/atom+xml” is designated. The line Ln3 specifies that the format acceptable to the client 2-1 is “Atom.” What is designated as the acceptable format is the content type placed in a body format of a NOTIFY message that is sent as a response to the SUBSCRIBE request.

The first embodiment utilizes SIP URIs as link destination information about feeds. For that reason, Atom is adopted to include information other than URLs. If RSS is arranged to include URIs of links other than their URLs as link destinations in the future, then RSS may be adopted. Alternatively, some other suitable data format may be employed.

In step S2 back in FIG. 4, the feed delivery section 102 responds by using a response code 200 if it accepts the request from the client 2-1. Although not shown in the sequence diagram of FIG. 4, the type of the content whose feed is what the client 2-1 desires to subscribe to is registered in the location management section 103 (see FIG. 1) of the SIP server 100 in association with the client 2-1 requesting the subscription.

In step S3, a feed F1 carrying the latest update information at this point is placed in the body of a NOTIFY request before the request is delivered by the feed delivery section 102 to the client 2-1. FIG. 5B shows a typical description of the NOTIFY request to be delivered. In the request shown in FIG. 5B, “feed” is designated in the event header of a line Ln4; and “application/atom+xml” is designated in a “Content-Type” header of a line Ln5. This shows that the type of the event to be reported at this point is “feed” and that the content type of the data format (i.e., body format) included in the body is “Atom.” The body of a line Ln6 holds the feed F1 to be delivered this time. If RSS is used instead of Atom, then a “MIME” type is designated in the Content-Type header.

The feed D1 delivered here was already sent to users who subscribe to the feed of EPG update information. To the client 2-1 desiring to subscribe anew, the feed F1 is the most recent update information and is thus delivered to the client 2-1 at this point. Upon receipt of the feed F1 in step S4, the client 2-1 responds by using a response code 200. The feeds generated by the feed generation section 101 have been stored in a memory or the like, not shown. The feed delivery section 102 retrieves feeds as needed from the storage preparatory to delivery.

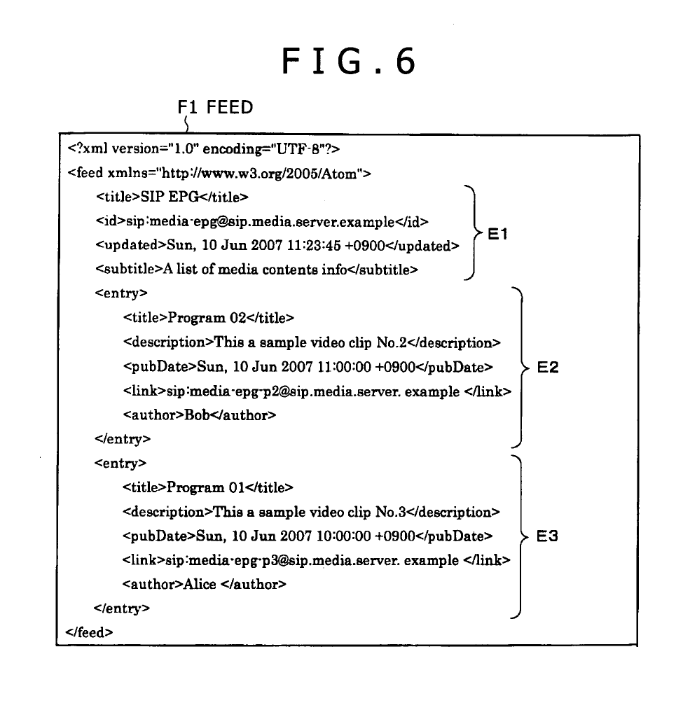

FIG. 6 shows a typical description of the feed F1. In the area indicated as an element E1 in FIG. 6, the line enclosed by <title> tags shows the title of the feed “SIP EPG”; the line enclosed by <id> tags shows the ID assigned to the feed; the line enclosed by <updated> tags shows the update date of the feed, “Sun. 10, Jun. 2007, 11:23:45”; and the line enclosed by <subtitle> tags shows the subtitle of the feed, “A list of media contents info.” Information about individual TV programs is shown in <entry> areas such as elements E2 and E3.

Update information about “Program 02” is written in the element E2, and update information about “Program 01” is given in the element E3. The lines enclosed by <pubDate> tags in the elements E2 and E3 show the dates on which the individual programs were last updated. More specifically, the update date of “Program 02” is “Sun. 10, Jun. 2007, 11:00:00” and the update date of “Program 03” is “Sun. 10, Jun. 2007, 10:00:00.” That is, the programs are listed in the feed F1 in chronological order from the bottom up. The lines enclosed by <link> tags indicate information about the locations where the programs are actually stored, the information being described in SIP URI such as “sip:media-epg-pl@sip.media.server.example.” The lines enclosed by <author> tags indicate the names of the persons who updated the resources (i.e., programs), such as “Carol” who updated “Program 03” and “Bob” who updated “Program 02.”

In other words, in the feed F1 shown in FIG. 6, the body areas enclosed by <entry> tags describe information about “Program 03” updated by “Carol” at 10:00, Sunday, Jun 10, 2007, and information about “Program 02” updated by “Bob” at 11:00, Sunday, Jun 10, 2007.

In step S5 back in FIG. 4, the programs (resources) are updated by the client 1-1, the resource holder. In step S6, the client 1-1 notifies the field generation section 101 in the SIP server 100 of a resource update using a PUBLISH request. In step S7, the feed generation section 101 in the SIP server 100 gives a response “200 OK” to the client 1-1. In step S8, the feed generation section 101 updates the feed F1 so as to generate a feed F2 based on the description in the PUBLISH request received from the client 1-1. In step S9, the generated feed F2 is sent to the feed delivery section 102.

In step S10, upon receipt of the feed F2, the feed delivery section 102 places the received feed into the body of a NOTIFY request before sending the request to the client 2-1. In step S11, having received the NOTIFY request, the client 2-1 returns a response “200 OK” to the feed delivery section 102.

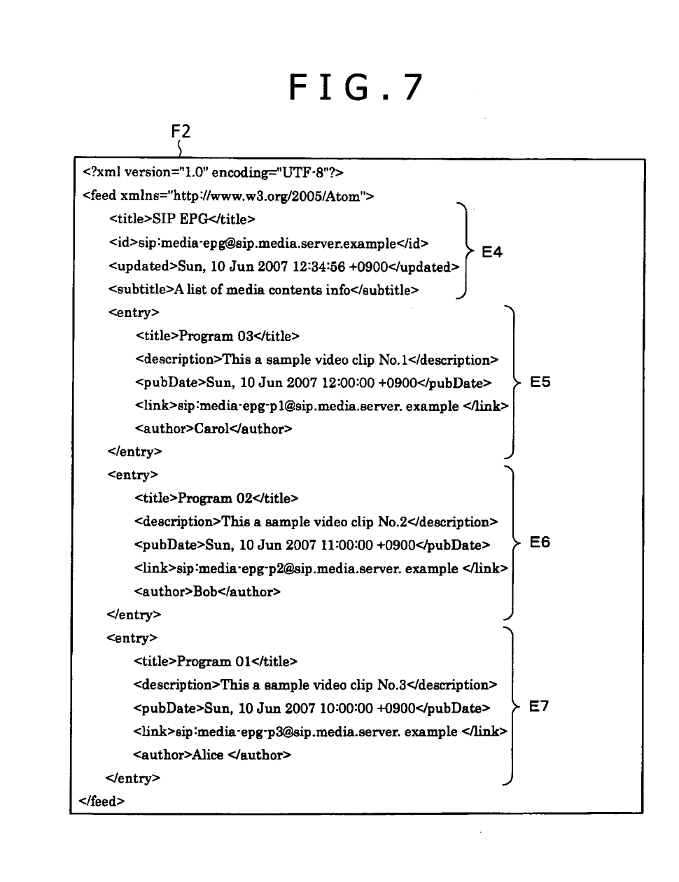

FIG. 7 shows a typical description of the feed F2. In the feed F2, elements E6 and E7 correspond to the elements E2 and E3 in the feed F1, respectively. That is, the update information about the individual programs described in the previously delivered feed is included unchanged. An element E5 placed above the element E6 in the description contains the most recent update information.

The element E5 retains information about “Program 01” updated by “Alice” at 12:00:00, Sunday, Jun 10, 2007. The feed F2 was shown updated in step S8 in the sequence diagram of FIG. 4. The feed generation section 101 generated the feed F2 based on the resource update information sent from the client 1-1 in step S7 of FIG. 4. For that reason, the (user of) client 101 turns out to be “Alice.”

The feed F2 also shows that the date in the line enclosed by <updated> tags in the element E4 (i.e., date on which the feed was generated) is “Sun. 10 Jun. 2007, 12:00:00,” the same as the date in the line enclosed by <pubDate> tags in the element E5. This means that the news described in the element E5 was updated at the same time that the feed including the resource update information was generated. That is because the process ranging from step S5 in which the resource is updated to step S10 in which the feed is delivered to the client 2-1 is carried out in succession. Resource update information is thus delivered to the user in real-time.

For purpose of simplification and illustration, the example above was shown having the resource updated, a feed generated, and the feed delivered at the same time. In practice, a limited amount of time period elapses from the time the resource is updated until the feed is delivered; it takes time to update the feed in step S8, and it takes time to send the feed from the feed generation section 101 to the feed delivery section 102. These time periods add up between the resource update date and the feed delivery time.

Step S12 and subsequent steps of FIG. 4 constitute the process in which the client 2-1 actually acquires the content of interest based on the information in the feed delivered by the feed delivery section 102 in step S10. As discussed above in reference to FIG. 3, the feed delivered to the client 2-1 is converted into HTML or like format and displayed on the display section 23 (see FIG. 3). The display section 23 displays resource storage location information in the form of links.

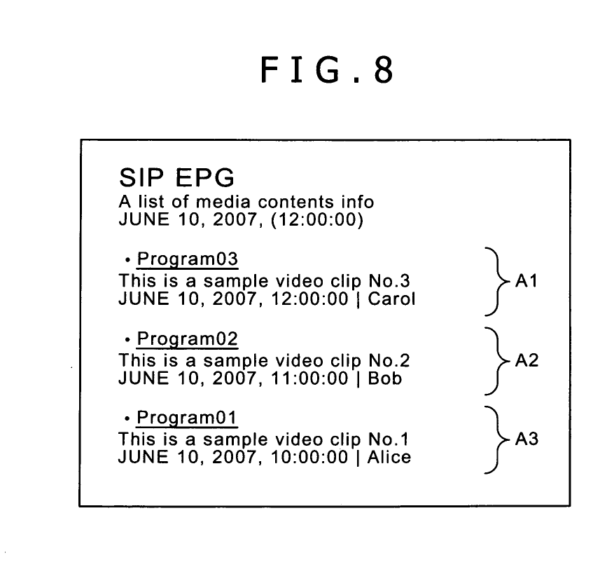

FIG. 8 schematically shows a typical display of resource update information on the display section 23. An area indicated as Al in FIG. 8 describes what was written in the element E5 in the feed F2 (see FIG. 7). That is, the area Al describes the information about “Program 03” having been updated by “Alice.” The line shown as “Program 03” is linked, and the line “sip:media-epg-pl@sip.media.server.example” is embedded between <link> tags in the element E5 of the feed F2. The area designated by A2 in FIG. 8 corresponds to the element E6 in the feed F2, and the area designated by A3 corresponds to the element E7 in the feed F2.

Any one or all of these links may be selected by the user of the client 2-1. When a link is selected, the client 2-1 sends to the client 1-1 (resource holder) a session establishment request in the form of an INVITE request in step S12 of FIG. 4.

The INVITE request sent in step S12 is furnished with an SDP (Session Description Protocol) part that includes the bandwidth desired by the client 2-1 (i.e., quality of service (QoS)) and codec information. If the client 1-1 having received the INVITE request accepts it, the client 1-1 returns a response “200 OK” to the client 2-1 in step S13. In step S14, a media session is established between the client 1-1 and the client 2-1. The client 2-1 acquires the content of interest through real-time communication following the establishment of the media session. The real-time communication is carried out illustratively under RTSP (Real-time Streaming Protocol).

According to the first embodiment of which the structure and processing were described above, the moment a resource is updated, a feed including information about that update is generated. The feed thus generated is sent immediately to the client (i.e. user) desiring to subscribe to that feed. In this manner, the user is able to acquire resource update information in real-time.

Also according to the first embodiment of which the structure and processing were discussed above, the steps ranging from the detection of a resource update to the delivery of a feed regarding the update are conducted by the SIP server 100. This eliminates the need for the client side to poll the server. With unnecessary access to the server thus discontinued, the burdens on the server and on the lines involved are alleviated.

Through the use of the first embodiment of which the structure and processing were explained above, the feed used to deliver resource update information may also include descriptions of such metadata as information about the authors of the resources and their subtitles. This allows the user to verify the resource update information and resource attribute information all at once. It is also possible to deliver in a single feed the information about a plurality of TV broadcast channels.

Also through the use of the first embodiment of which the structure and structure were depicted above, the feed is arranged to carry resource storage location information as well. The information is displayed in the form of links on the display section or the like, allowing the user to click on a suitable link or links to acquire the desired resource or resources easily.

Furthermore, according to the first embodiment of which the structure and processing were described above, the user issues a feed subscription request using a SUBSCRIBE request. In response to the request, the resource update information that the user desires to be notified of is delivered to the user in the form of a NOTIFY request. This means that only the information desired by the user is delivered to the user when needed.

Although the first embodiment above was shown to let the client 1-1 as the resource holder notify the SIP server 100 of resource update information using the so called PUBLISH method under SIP, this is not limitative of the present invention. Alternatively, resource update information may be exchanged between the resource holder and the SIP server 100 by use of a SUBSCRIBE request and a NOTIFY request.

In the preceding alternative case, the SIP server 100 using the SUBSCRIBE request makes an event state (i.e., resource update) notification request beforehand to the client 1-1 acting as the resource holder. This arrangement prompts the person who updates resources to send a NOTIFY message to the SIP server 100 every time a resource is updated. As another alternative, the resource holder may notify the SIP server 100 of resource updates using some other suitable protocol such as HTTP.

According to the first embodiment discussed above, the feed generation section 101 was shown sending feeds to the feed delivery section 102. Alternatively, the feeds themselves may not be handled; only feed update information and information about the locations where the feeds are stored may be sent. In this case, a file system by which to manage feed files may be separately provided to accommodate the feeds generated by the feed generation section 101. Whenever a feed is stored into the file system, an update notification including feed storage location information such as “/xml/feed/new.xml” may be sent from the feed generation section 101 to the feed delivery section 102.

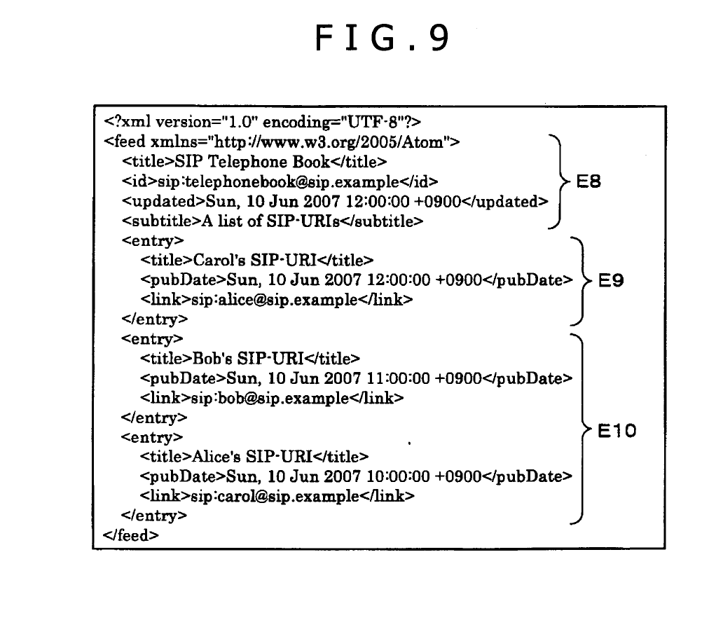

According the first embodiment above, the EPG of the programs to be offered on IPTV is delivered as feeds. Alternatively, other information may be delivered in the form of feeds as long as the information is about the resources managed using SIP URIs. FIG. 9 schematically shows a typical feed description of information about updates in a telephone directory covering IP phone terminals.

The area indicated as an element E8 includes a feed title, feed ID information, and feed update date information. Those areas of the body which are indicated as elements E9 and E10 include telephone numbers expressed using SIP URIs. The element E9 is shown to contain Bob's telephone number “sip:bob@sip.example,” and a telephone number update date “Sun. 10 Jun 2007, 12:00:00” enclosed between <pubDate> tags. The element E10 is shown to include update information about Carol's telephone number. In this manner, the update information about the telephone directory may be delivered using the feed along with metadata.

### Second Embodiment

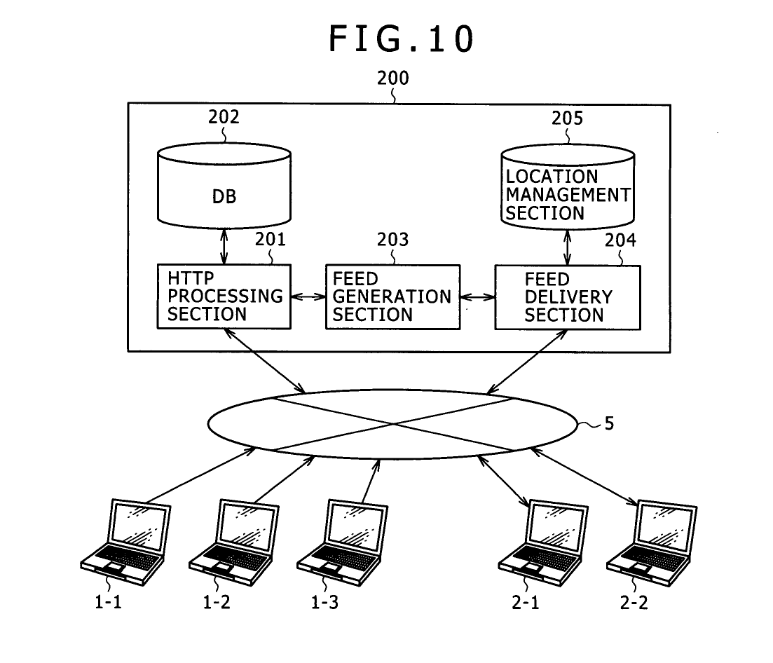

The second embodiment of the present invention will now be described in reference to FIGS. 10 through 14B. The second embodiment involves delivering as feeds the update information about news formed by text data and video data. It is assumed that the text data and video data include two kinds of data: those managed using SIP URIs, and those managed by Web servers. In the ensuing description, the resources managed using SIP URIs will be referred to as SIP resources and the resource managed by Web servers as Web resources.

FIG. 10 is a schematic view explanatory of how a system is configured as the second embodiment of the present invention. In FIG. 10, clients 1-1 through 1-3 and clients 2-1 and 2-2 are connected to an application server 200 on a network 5. The user of the client 1-1 in FIG. 10 is a resource holder who generates and updates resources managed using SIP URIs. The user of the client 1-2 is a resource holder who generates and updates resources managed by Web servers. The user of the client 1-3 is a resource holder who generates and updates both the resources managed using SIP URIs and the resources managed by Web servers. The users of the clients 2-1 and 2-2 make use of these resources. The application server 200 is structured to have the capabilities of both s SIP server and a Web server.

The application server 200 is made up of an HTTP (Hypertext Transfer Protocol) processing section 201, a database (DB) 202, a feed generation section 203, a feed delivery section 204, and a location management section 205. The HTTP processing section 201 analyzes and responds to HTTP requests sent from clients. For example, if a resource is sent from the client 1-2 or 103 having recourse to the so-called POST method or PUT method, then the HTTP processing section 201 places the received resource into the database 202 for storage. If a GET command is sent from the client 1-2 or 1-3, the HTTP processing section 201 reads from the database 202 the resource designated in that command and sends the retrieved resource to the requesting client.

The moment a resource update is detected, i.e., as soon as the HTTP processing section 201 receives a POST command or a PUT command from the client 1-2 or 1-3, the feed generation section 203 generates a feed that includes content update information and forwards the generated feed to the feed delivery section 204. The feed delivery section 204 and location management section 205 operate in the same manner as the feed delivery section 102 and location management section 103 in FIG. 1 and thus will not be discussed further. The internal structure of the application server 200 is the same as that shown in FIG. 2 while the internal structure of the clients 1-2 and 1-3 is the same as that depicted in FIG. 3. Thus these structures will not be explained further.

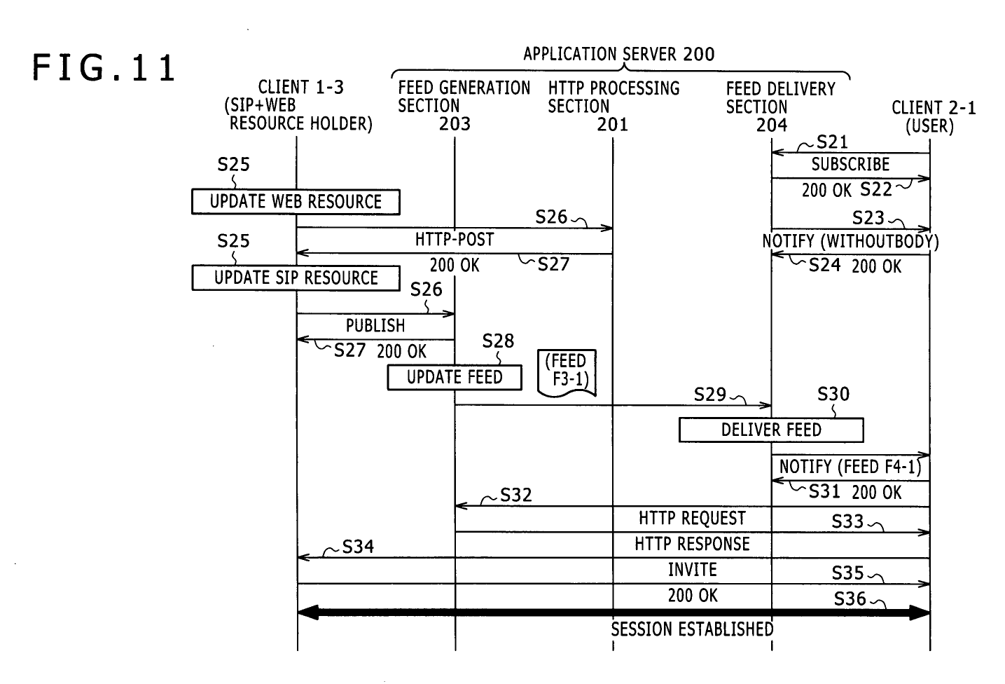

Described below in reference to FIG. 11 are the steps performed in such a manner that the client 2-1 first issues a feed subscription request to the application server 200, that a feed including resource update information is then sent to the client 2-1, and that the client 2-1 actually comes to acquire the resource of interest based on the resource update information.

In step S21 of FIG. 11, the client 2-1 sends a feed subscription request in the form of a SUBSCRIBE request to the feed delivery section 204 of the application server 200. In step S22, the feed delivery section 204 returns a response “200 OK” to the client 2-1. At this point, it is assumed that a feed regarding the resource that the client 2-1 desires to subscribe to has yet to be generated (i.e., that no feed is stored in a memory). In step S23, the feed delivery section 204 sends a NOTIFY request without a body to the client 2-1. In step S24, the client 2-1 upon receipt of the NOTIFY request returns a response “200 OK” to the feed delivery section 204.

In step S25, the client 1-3 holding both the SIP resources and the Web resources updates news covering these two kinds of resources. In other words, the Web and SIP resources are updated simultaneously. In step S26, the client 103 sends update information about the Web resources to the HTTP processing section 201 using a POST command under HTTP and update information about the SIP resources to the feed generation section 203 using a PUBLISH request. Although not shown in FIG. 11, the resources attached to the POST command are written to suitable locations in the database 202 by the HTTP processing section 201. In step S27, the HTTP processing section 201 and feed generation section 203 each return a response “200 OK” to the client 1-3. In FIG. 11, the client 1-3 is shown to use the POST command under HTTP when notifying the application server 200 of the Web resource updates. Alternatively, some other suitable command such as a PUT command may be used instead.

In step S28, the feed generation section 203 generates a feed F3-1 based on the resource update notification sent from the client 1-3 in step S25. In step S29, the feed generation section 203 sends the generated feed F3-1 to the feed delivery section 204.

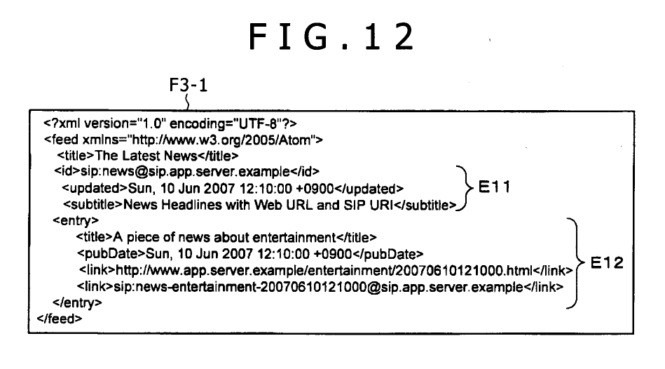

FIG. 12 schematically shows a typical description of the feed F3-1. The area indicated as an element E11 includes a feed title (“The Latest News”), a feed ID (sip:news@sip.app.server.example), a feed update date (Sun. 10 Jun. 2007, 12:10:00), and a feed subtitle (“News Headlines with Web URL and SIP URI”). The area enclosed by <entry> tags in the body constituting an element E12 contains resource (i.e., news) update information.

In the element E12, the line enclosed by <title> tags contains news update information titled “A piece of news about entertainment.” The update date of that information is shown to be “Sun. 10 Jun. 2007, 12:10:00” on the line enclosed by <putDate> tags. The update date is the same as the feed generation date (enclosed by <updated> tags in the element E11). It can be seen that the feed was generated at the same time that the news titled “A piece of news about entertainment” was updated.

In the element E12, there are two lines each enclosed by <link> tags, one line being “http://www.app.server.example/entertainment/20070610121000.html” linked to a Web resource, the other line being “sip:news-entertainment-20070610121000@sip.app.server.example” linked to a SIP resource. It can now be seen that the client 1-2 updated the Web resource that is stored at “http://www.app.server.example/entertainment/20070610121000.html” and the SIP resource that is stored at “sip:news-entertainment-20070610121000@sip.app.server.example,” the two resources constituting the news titled “A piece of news about entertainment.”

The feed F3-1 forwarded from the feed generation section 203 to the feed delivery section 204 in step S29 of FIG. 11 is then sent from the feed delivery section 204 to the client 2-1 in step S30 through the use of a NOTIFY request. In step S31, the client 2-1 having received the NOTIFY request returns a response “200 OK” to the feed delivery section 204.

If the user of the client 2-1 selects the Web resource described in the element E12 of the feed F3-1 (see FIG. 12), then the client 2-1 sends an HTTP request in step S32 to the HTTP processing section 201 of the application server 200 as a resource acquisition request. The HTTP request used here is typically a GET command. In step S33, upon receipt of the HTTP request, the HTTP processing section 201 sends the requested resource to the client 2-1 by use of an HTTP response.

If the user of the client 2-1 selects the SIP resource described in the element E12 of the feed F3-1 (see FIG. 12), then the client 2-1 using an INVITE request sends a session establishment request to the client 1-3 holding the resource in question in step S34. If the client 1-3 accepts the INVITE request, then the client 1-3 returns a response “200 OK” to the client 2-1 in step S35. In step S36, a media session is established between the clients. The client 2-1 acquires the content of interest through real-time communications following establishment of the media session.

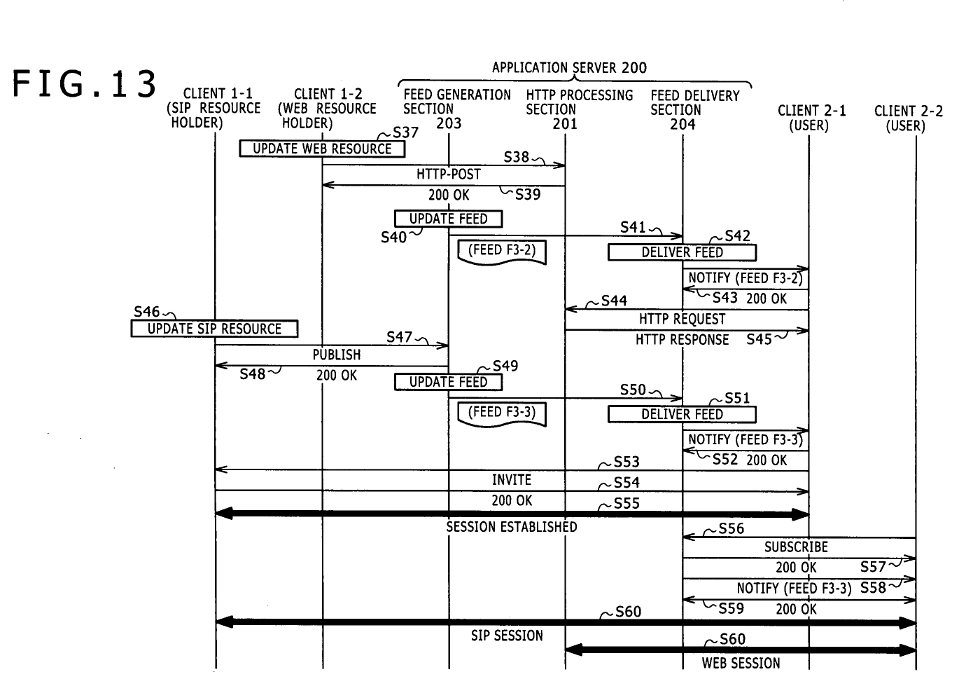

Described below in reference to FIG. 13 are typical steps carried out in such a manner that resources are updated by the client 1-1 as the SIP resource holder and by the client 1-2 as the Web resource holder, that resource update information is delivered to the client 2-1,and that the client 2-1 acquires a desired resource. The sequence diagram of FIG. 13 is temporally continued from the sequence diagram of FIG. 11. It is assumed that the client 2-1 has already sent a feed subscription request to the feed delivery section 204 of the application server 200.

In step S37, the client 1-2 as the Web resource holder updates a Web resource. In step S38, the client 1-2 sends the resource to the HTTP processing section 201 of the application server 200 using a POST command under HTTP. In step S39, upon receipt of the POST command, the HTTP processing section 201 stores into the database 202 the resource contained in the POST command and returns a response “200 OK” to the client 1-2.

On detecting that the POST command from the client 1-2 is received by the HTTP processing section 201, the feed generation section 203 of the application server 200 updates the feed F3-1 (see FIG. 12) so as to generate a feed F3-2 based on the information found in the POST command in step S40. In step S41, the feed generation section 203 sends the generated feed F3-2 to the feed delivery section 204.

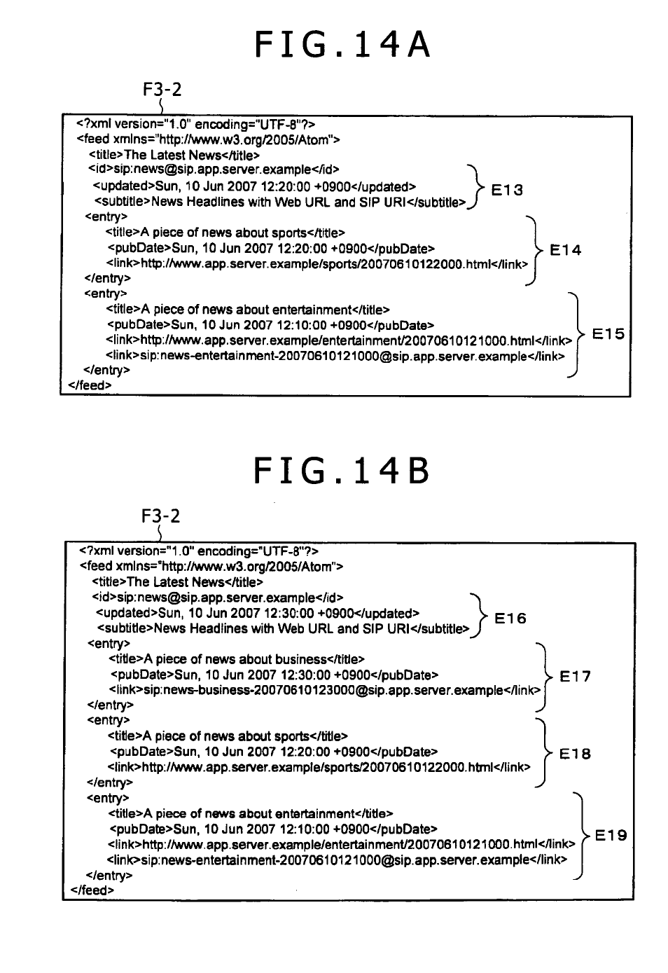

FIG. 14A shows a typical description of the feed F3-2. In the feed F3-2, a bottom area indicated as an element E15 contains the same information as that in the element E12 of FIG. 12. The area designated as an element E14 above the element E15 contains the resource update information notified by the client 1-2. In the element E14, the line enclosed by <title> tags shows update information about the news titled “A piece of news about sports.” The update date of the news is “Sun. 10 Jun 2007, 12:20:00” as indicated in the line enclosed by <putDate> tags. The update date is the same as the feed creation date (shown enclosed by <updated> tags in the element E13). That is, the feed was generated at the same time that the news titled “A piece of news about sports” was updated.

In the element E14, the line enclosed by <link> tags contains an address “http://www.app.server.example/sports/20070610122000.thml.” This address is the location where the data constituting the news in question is stored.

The feed F3-2 forwarded from the feed generation section 203 to the feed delivery section 204 in step S41 of FIG. 13 is then sent from the feed delivery section 204 to the client 2-1 in step S42 in the form of a NOTIFY request. In step S43, the client 2-1 having received the NOTIFY request returns a response “200 OK” to the feed delivery section 204.

If the user of the client 2-1 selects the Web resource described in the element E14 of the feed F3-2 (see FIG. 14A), then the client 2-1 in step S44 sends an HTTP request to the HTTP processing section 201 of the application server 200 as a resource acquisition request. In step S45, the HTTP processing section 201 having received the HTTP request sends the requested resource to the client 2-1 using an HTTP response.

In step S46, the client 1-2 as the SIP resource holder updates a SIP resource. In step S47, the client 1-1 notifies the feed generation section 203 in the application server 200 of the resource update using a PUBLISH request. In step S48, the feed generation section 203 returns a response “200 OK” to the client 1-1. In step S49, the feed generation section 203 updates the feed F3-2 so as to generate a feed F3-3 based on the PUBLISH request received from the client 1-1. In step S50, the feed generation section 203 sends the generated feed F3-3 to the feed delivery section 204.

In step S51, the feed delivery section 204 receives the feed F3-3 and places its content into the body of a NOTIFY request before sending the request to the client 2-1. In step S52, the client 2-1 having received the NOTIFY request returns a response “200 OK” to the feed delivery section 204.

FIG. 14B shows a typical description of the feed F3-3. The areas indicated as elements E18 and E19 in the feed F3-3 correspond to the elements E14 and E15, respectively, in the fed F3-2 (see FIG. 14A). That is, the update information about each piece of news contained in the previously delivered feed is furnished unchanged. The most recent update information is contained in the area designated as an element E17.

In the element E17, the line enclosed by <title> tags contains the update information about the news titled “A piece of news about business.” The update date of the news is given as “Sun. 10 Jun 2007, 12:30:00” enclosed by <putDate> tags. The date is the same as the feed generation date (enclosed by <updated> tags in the element E17). It can be seen that the feed was generated at the same time that the news titled “A piece of news about business” was updated.

In the element E17, the area enclosed by <link> tags contains information about the location where the SIP resource is stored (e.g., at “sip:news-business-20070610123000@sip.app.server.example”). This means that what was updated by the client 1-1 is the news that is titled “A piece of news about business” and constituted by the SIP resource stored at “sip:news business 20070610123000@sip.app.server.example.”

If the user of the client 2-1 having received the feed selects the SIP resource described in the element E17 of the feed F3-3, then the client 2-1 sends a session establishment request to the client 1-1 holding the resource in question, using an INVITE request in step S53 of FIG. 13. If the client 1-1 having received the INVITE request accepts that request, the client 1-1 returns a response “200 OK” to the client 2-1 in step S54. In step S55, a media session is established between the client 1-1 and the client 2-1. The client 2-1 acquires the content of interest through real-time communications following establishment of the media session.

In step S56, the client 2-2 sends a feed subscription request regarding news to the application server 200 through the use of a SUBSCRIBE request. In step S57, the feed delivery section 204 of the application server 200 returns a response “200 OK” to the client 2-2. Because the most recent feed of the news that the client 2-2 desires to be delivered is the feed F3-3, the feed delivery section 204 delivers the feed F3-3 to the client 2-2 using a NOTIFY request in step S58. In step S59, the client 2-2 having received the feed F3-3 returns a response “200 OK” to the feed delivery section 204.

If the user of the client 2-2 selects the SIP resource described in the element E17 of the feed F3-3 (see FIG. 14B), then a SIP session is established in step S60 between the client 2-2 and the client 1-1 holding the SIP resource in question. During the session, the client 2-2 acquires the resource of interest (news in this case).

If the user of the client 2-2 selects the Web resource described in the element E18 of the feed F3-3 (see FIG. 14B), then a HTTP (Web) session is established in step S61 between the client 2-2 and the HTTP processing section 201 of the application server 200. While the session is underway, the client 2-2 acquires the resource of interest.

According to the second embodiment of which the structure and processing were described above, the effects provided by the first embodiment are supplemented by the benefits of the new arrangements. Illustratively, there are cases where a single piece of news is made up of a plurality of resources managed in different formats such as SIP URI and Web URL. Items of update information about these resources are placed in a single feed to be delivered to the client. The client is thus able to acquire desired resources without becoming aware of the locations where they are stored.

### Third Embodiment

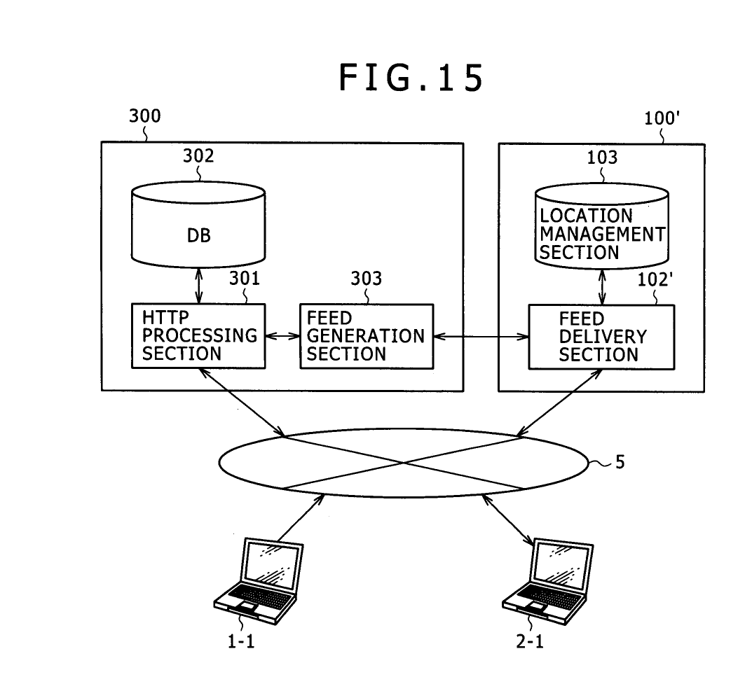

The third embodiment of the present invention will now be described in reference to FIGS. 15 through 17. As with the second embodiment, the third embodiment is implemented in such a manner that the update information about news is delivered in the form of feeds. What characterizes the third embodiment is that the text data and video data constituting the news are all managed by Web servers.

In FIG. 15, a Web server 300, a SIP server 100′, and clients 1-1 and 2-1 are interconnected on a network 5. The user of the client 1-1 is a Web resource holder. The user of the client 2-1 subscribes to the news generated or updated by the resource holder.

The Web server 300 is made up of an HTTP processing section 301, a database 302, and a feed generation section 303. The SIP server 100′ is constituted by a feed delivery section 102′ and a location management section 103′. What characterizes the system configuration of the third embodiment is that feeds are generated by the Web server 300 and that the generated feeds are delivered by the SIP server 100′. The HTTP processing section 301, database 302, and feed generation section 303 perform substantially the same processes as the above-described HTTP processing section 201, database 202, and feed generation section 203, respectively, in FIG. 10 and thus will not be discussed further. The feed delivery section 102′ and location management section 103′ carry out substantially the same processes as the feed delivery section 102 and location management section 103 in FIG. 1, or as the feed delivery section 204 and location management section 205 in FIG. 10, respectively, and thus will not be explained further. The internal structure of the Web server 300 and SIP server 100′ is substantially similar to what is shown in FIG. 2, and the internal structure of the clients 1-1 and 2-1 is approximately the same as what is indicated in FIG. 3, so that these structures will not be described further.

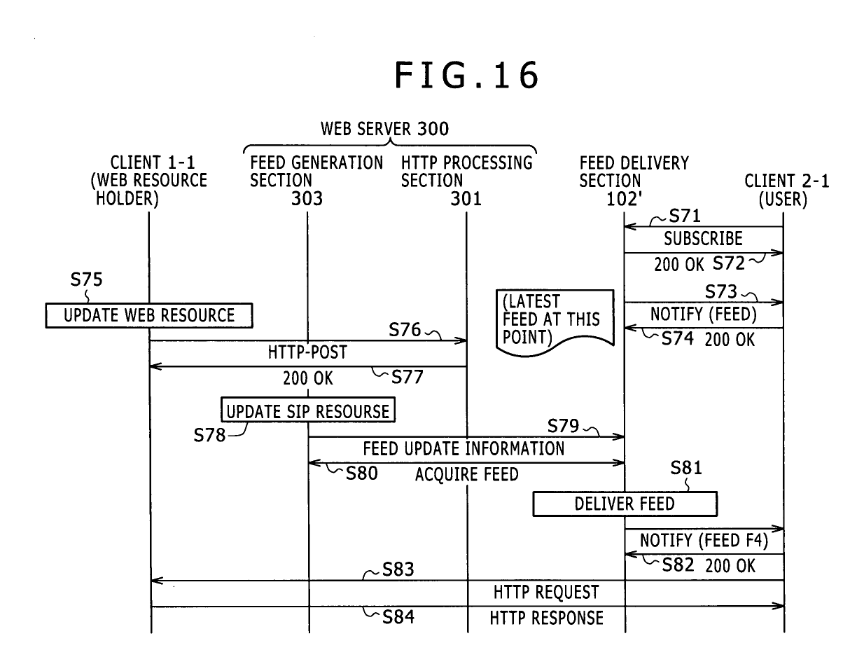

Described below in reference to FIG. 16 are typical steps performed in such a manner that the client 2-1 sends a feed subscription request to the SIP server 100′, that a feed including update information about a desired resource is then sent to the client 2-1, and that the client 2-1 actually comes to acquire the resource in question on the basis of the resource update information received.

In step S71, the client 2-1 sends a feed subscription request to the feed delivery section 102′ of the SIP server 100′ using a SUBSCRIBE request. In step S72, the feed delivery section 102′ returns a response “200 OK” to the client 2-1. In step S73, the feed delivery section 102′ delivers to the client 2-1 a feed containing the latest update information at this point through the use of a NOTIFY message. In step S74, the client 2-1 having received the NOTIFY request returns a response “200 OK” to the feed delivery section 102′.

In step S75, the client 1-1 holding Web resources updates news made up of these resources. In step S76, the client 1-1 sends the news to the HTTP processing section 301 of the Web server 300 using a POST command under HTTP. Although not shown in FIG. 16, the resources attached to the POST command are written to suitable locations in the database 302 by the HTTP processing section 301. In step S77, the HTTP processing section 301 returns a response “200 OK” to the client 1-1.

In step S78, the feed generation section 303 updates the feed so as to generate a feed F4 based on the description in the POST command received by the HTTP processing section 301 in step S76. The feed F4 thus generated is written to a suitable location in the database 302 (see FIG. 15). In step S79, the feed generation section 303 sends feed update information including information about where the feed F4 is stored to the feed delivery section 102′ of the SIP server 100′. In step S80, the feed delivery section 102′ acquires the feed F4 from the database 302 based on the received feed update information. In step S81, the feed delivery section 201′ places the acquired feed F4 into the body of a NOTIFY request before sending that request to the client 2-1. In step S82, the client 2-1 having received the NOTIFY request returns a response “200 OK” to the feed delivery section 102′.

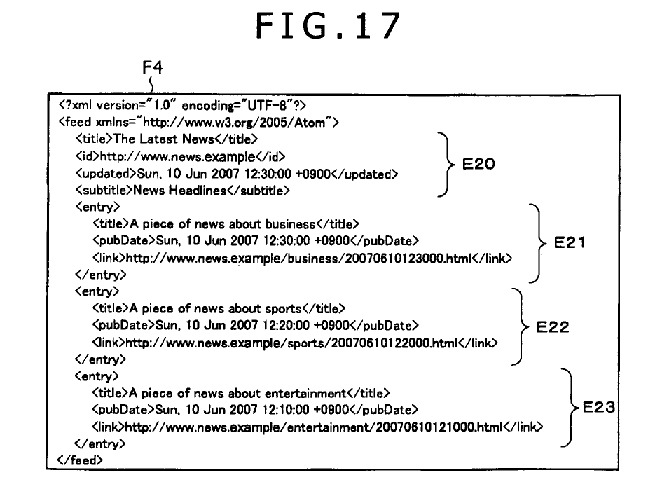

FIG. 17 shows a typical description of the feed F4. The area indicated as an element E20 contains a feed title (“The Latest News”), a feed ID (http://www.news.com.example), a feed update date (Sun. 10 Jun 2007, 12:30:30), and a feed subtitle (“News Headlines”). In the areas designated as elements E21 through E23, the body portions each enclosed by <entry> tags contain update information about the respective news. The news update dates each enclosed by <pubDate> tags are shown in chronological order from the bottom up. That is, the bottommost element E23 indicates the oldest news update date, followed by the elements E22 and E21 above showing more recent news update dates.

In other words, the news update date described in the element E21 is the most recent date, “Sun. 10 Jun 2007, 12:30:00,” shown enclosed by <putDate> tags. This date is the same as the feed generation date (shown enclosed by <updated> tags in the element E20). It can be seen that the news contained in the element E21 was updated by the client 1-1 at the same time that the feed F4 was generated.

The elements E21 through 23 each contain the resource storage location information enclosed by <link> tags. For example, the element E21 has “http://www.news.com/business/20070610123000.html” embedded therein.

If the user of the client 2-1 selects the Web resource described in the element E21 of the feed F4, then the client 2-1 sends an HTTP request to the HTTP processing section 301 of the client 2-1 in step S83 of FIG. 16. Upon receipt of the HTTP request, the HTTP processing section 301 sends the resource to the client 2-1 using an HTTP response in step S84.

According to the third embodiment of which the structure and processing were discussed above, the information about the resources managed by Web servers is also delivered to the client using the NOTIFY request under SIP. The user can then acquire resource update information and the like on a real-time basis.

Also according to the third embodiment of which the structure and processing were explained above, the feed generation section 203 notifies the feed delivery section 102′ of feed update information. However, this is not limitative of the present invention. Alternatively, the feed delivery section 102′ may continuously monitor the time of feed file generation and, as soon as an update is detected, may acquire a feed file from the feed generation section 203.

According to the first through the third embodiments of the present invention described above, the feed generation section and the feed delivery section are structured separately. Alternatively, these two sections may be integrally formed. More specifically, the feed generation section and feed delivery section may be implemented by multi-threading the same process. As another alternative, the feed generation section and feed delivery section may be implemented as different processes.

Where the feed generation section and feed delivery section are implemented in the form of a multi-thread arrangement for the same process, the two sections may share a single memory. When a feed generated by the feed generation section is stored into the memory, there is no need to move the feed between the feed generation section and the feed delivery section (as in step S9 of FIG. 4). Where the feed generation section and feed delivery section are implemented as different processes, what is placed into the memory used by the feed generation section can be copied to the memory utilized by the feed delivery section. This, as in the case of multi-threading, eliminates the need for moving feeds between the two sections.

It should be understood by those skilled in the art that various modifications, combinations, sub combinations and alterations may occur depending on design requirements and other factor in so far as they are within the scope of the appended claims or the equivalents thereof.

What is claimed is:

1. An information delivery apparatus for delivering update information about a specific resource designated by a terminal to said terminal, said information delivery apparatus comprising:
a delivery section configured to receive from said terminal a request to deliver said update information about said resource and deliver said update information to said terminal; and
an update information generation section configured to generate said update information about said resource upon detection of an update of said resource, before outputting the generated update information to said delivery section;
wherein, the moment said update information is acquired from said update information generation section, said delivery section delivers the acquired update information to said terminal.

2. The information delivery apparatus according to claim 1, wherein said update information generation section describes in the form of a feed said update information about said resource of which the update is detected.

3. The information delivery apparatus according to claim 2, wherein said delivery section delivers said feed to said terminal by use of a method called SIP which stands for session initiation protocol.

4. The information delivery apparatus according to claim 3, wherein, in response to the delivery request in the form of a subscribe request received from said terminal, said delivery section delivers said feed in the form of a NOTIFY request to said terminal.

5. The information delivery apparatus according to claim 4, wherein said update information generation section detects the update of said resource designated in said subscribe request received from said terminal.

6. The information delivery apparatus according to claim 5, wherein said resource is stored at a location managed by use of a URI which stands for universal resource identifier.

7. The information delivery apparatus according to claim 2, wherein said update information generation section describes attribute information about said resource in said feed.

8. The information delivery apparatus according to claim 7, wherein said attribute information about said resource includes information about a specific location where said resource is stored.

9. The information delivery apparatus according to claim 4, wherein said delivery section designates said feed in an event field in a header of said NOTIFY request and embeds said feed in a body of said NOTIFY request.

10. An information delivery method for use with an information delivery apparatus for delivering update information about a specific resource designated by a terminal to said terminal, said information delivery method comprising the steps of:
receiving from said terminal a request to deliver said update information about said resource;
generating said update information about said resource upon detection of an update of said resource; and
delivering the generated update information to said terminal.

11. An information delivery system comprising
a terminal and an information delivery apparatus for delivering update information about a specific resource designated by said terminal to said terminal
wherein said terminal includes a communication section configured to send to said information delivery apparatus a request to deliver said update information about said resource, said communication section being further configured to receive said update information from said information delivery apparatus; and
said information delivery apparatus includes:
a delivery section configured to receive from said terminal said request to deliver said update information about said resource and delivering said update information to said terminal; and
an update information generation section configured to generate said update information about said resource upon detection of an update of said resource, before outputting the generated update information to said delivery section;
the moment said update information is acquired from said update information generation section, said delivery section delivers the acquired update information to said terminal; and
said terminal acquires said resource based on storage location information received through said communication section, said storage location information indicating a specific location where said resource is stored.

12. An information delivery apparatus for delivering update information about a specific resource designated by a terminal to said terminal, said information delivery apparatus comprising:
delivery means for receiving from said terminal a request to deliver said update information about said resource and delivering said update information to said terminal; and
update information generation means for generating said update information about said resource upon detection of an update of said resource, before outputting the generated update information to said delivery means;
wherein, the moment said update information is acquired from said update information generation means, said delivery means delivers the acquired update information to said terminal.
